(19) United States
(12) Patent Application Publication
(10) Pub. No.: US 2019/0141758 A1
(43) Pub. Date: May 9, 2019

(54) SESSION MANAGEMENT FOR MASSIVE MACHINE TYPE COMMUNICATION IN 5G NETWORKS

(71) Applicant: Huawei Technologies Co., Ltd., Shenzhen (CN)

(72) Inventors: Riccardo TRIVISONNO, Munich (DE); Xueli AN, Munich (DE)

(21) Appl. No.: 16/238,992

(22) Filed: Jan. 3, 2019

Related U.S. Application Data
(63) Continuation of application No. PCT/EP2016/065702, filed on Jul. 4, 2016.

(51) Int. Cl. H04W 76/10; H04W 4/70

(52) U.S. Cl. CPC H04W 76/10; H04W 4/70

(57) ABSTRACT

The invention relates to a control plane network entity for managing communication between an access network and a core network of a wireless communication system, wherein the CP network entity comprises a processor configured, in response to a connectivity request from a first physical device, to assign the first physical device to a virtual device and to establish an aggregate CN bearer for the virtual device. The first physical device is associated with a device class parameter and the processor is configured, in response to a connectivity request from a second physical device, to assign the second physical device to the virtual device.

### CROSS-REFERENCE TO RELATED APPLICATIONS

This application is a continuation of International Application No. PCT/EP2016/065702, filed on Jul. 4, 2016, the disclosure of which is hereby incorporated by reference in its entirety.

### TECHNICAL FIELD

In general, the present application relates to communication networks. More specifically, the present application relates to devices and methods for session management for massive Machine Type Communication in 5G networks.

### BACKGROUND

Current research and standardisation activities in the field of communication networks envision massive Machine Type Communications (mMTC) as one of the key use cases for next generation networks. The reason is twofold. On one side, mMTC group together a wide family of use cases related to massive Internet of Things, expected to have relevant market and business impact in the coming years. On the other side, the need to support mMTC generates a set of challenging performance and functional requirements which can hardly be met by any cost efficient re-engineering of 4G systems (i.e. LTE/EPC Rel 13 compliant or older). The relevance of the use case is also reflected in the dedicated 3GPP Rel 14 SA1 SI, where key requirements are analysed (3GPP TR 22.861 V1.0.0 (2016-02), Feasibility Study on New Services and Markets Technology Enablers for Massive Internet of Things; Stage 1 (Release 14)).

In the Evolved Packet System (EPS), the Session Management relies on a connectivity model based on the “EPS Bearer” and the “Always ON” concepts.

As specified in 3GPP TS23.401 V13.6.1 (2015-12); General Packet Radio Service (GPRS) enhancements for Evolved Universal Terrestrial Radio Access Network (E-UTRAN) access (Release 13), the Evolved Packet System (EPS) provides connectivity between a User Equipment (UE) and a public land mobile network (PLMN) external packet data network (PDN). This is referred to as PDN Connectivity Service. In particular, IP PDN Connectivity Service is provided.

The IP PDN Connectivity Service supports the transport of traffic flow aggregate(s), consisting of one or more Service Data Flows (SDFs). The concept of SDF is defined in 3GPP TS23.203 V13.7.0 (2016-03); Policy and charging control architecture (Release 13) as an aggregate set of packet flows carried through the PCEF that matches a service data flow template.

The EPS bearer is the minimum level of granularity at which Quality of Service, mobility and security are provided within EPS. This means, SDFs mapped to the same EPS bearer are treated with the same Quality of Service, mobility and security policy.

When a UE attaches to a PDN, after authentication, it is allocated an IP address and an EPS Bearer, and it remains established throughout the lifetime of the PDN connection to provide the UE with Always-ON IP connectivity to that PDN. That bearer is referred to as the default bearer. Any additional EPS bearer that is established to the same PDN is referred to as a dedicated bearer. Dedicated bearers are established when the UE issues a Service Request, or when the network triggers a Service Request.

The initial bearer level Quality of Service (QoS) parameter values of the default bearer are assigned by the network, based on subscription data. The decision to establish or modify a dedicated bearer can only be taken by the EPC, and the bearer level QoS parameter values are always assigned by the EPC.

An EPS bearer is referred to as a Guaranteed Bit Rate (GBR) bearer if dedicated network resources related to a Guaranteed Bit Rate (GBR) value that is associated with the EPS bearer are permanently allocated at bearer establishment. Otherwise, an EPS bearer is referred to as a Non-GBR bearer.

The EPS bearer is composed by the concatenation of Radio Bearer, S1 Bearer and S5/S8 Bearer, as shown in FIG. 1.

An EPS bearer uniquely identifies traffic flows that receive a common QoS treatment between a UE and a PDN GW. An EPS bearer is also associated to packet filters determining the treatment packets will receive on that bearer.

The EPS bearer traffic flow template (TFT) is the set of all packet filters associated with that EPS bearer. An UpLink Traffic Flow Template (UL TFT) is the set of uplink packet filters in a TFT. A DownLink Traffic Flow Template (DL TFT) is the set of downlink packet filters in a TFT. Every dedicated EPS bearer is associated with a TFT. A TFT may be also assigned to the default EPS bearer. The UE uses the UL TFT for mapping traffic to an EPS bearer in the uplink direction. The PCEF uses the DL TFT for mapping traffic to an EPS bearer in the downlink direction. The UE may use the UL TFT and DL TFT to associate EPS Bearer Activation or Modification procedures to an application and to traffic flow aggregates of the application. Therefore, the PDN Gateway (PDN GW) shall, in the “Create Dedicated Bearer Request” and the “Update Bearer Request” messages, provide all available traffic flow description information (e.g. source and destination IP address and port numbers and the protocol information).

In more detail and under reference to FIG. 2, which shows the EPS bearer composition according to the standard TS 23.401, an EPS bearer is realized by the following elements. In the UE, the UL TFT maps a traffic flow aggregate to an EPS bearer in the uplink direction. In the PGW, the DL TFT maps a traffic flow aggregate to an EPS bearer in the downlink direction. A Radio Bearer transports the packets of an EPS bearer between a UE and an eNB. If a Radio Bearer exists, there is a one-to-one mapping between an EPS bearer and this Radio Bearer. A S1 bearer transports the packets of an EPS bearer between an eNB and a SGW. An E-RAB (E-UTRAN Radio Access Bearer) refers to the concatenation of an S1 Bearer and the corresponding Radio Bearer. A S5/S8 Bearer transports the packets of an EPS bearer between a SGW and a PGW. A UE stores a mapping between an uplink packet filter and a radio bearer to create the mapping between a traffic flow aggregate and a Radio Bearer in the uplink. A PGW stores a mapping between a downlink packet filter and a S5/S8 Bearer to create the mapping between a traffic flow aggregate and a S5/S8 Bearer in the downlink. An eNB stores a one-to-one mapping between a Radio Bearer and a S1 Bearer to create the mapping between a Radio Bearer and a S1 Bearer in both the uplink and downlink. A SGW stores a one-to-one mapping between a S1 Bearer and a S5/S8 Bearer to create the mapping between a Si bearer and a S5/S8 Bearer in both the uplink and downlink direction.

The PGW routes downlink packets to the different EPS bearers based on the downlink packet filters in the TFTs assigned to the EPS bearers in the PDN connection. Upon reception of a downlink data packet, the PGW evaluates for a match, first the downlink packet filter that has the lowest evaluation precedence index and, if no match is found, proceeds with the evaluation of downlink packet filters in increasing order of their evaluation precedence index. This procedure shall be executed until a match is found, in which case the downlink data packet is tunneled to the SGW on the EPS bearer that is associated with the TFT of the matching downlink packet filter. If no match is found, the downlink data packet shall be sent via the EPS bearer that does not have any TFT assigned.

Default bearer establishment requires time, computation and storage resources at the eNB, the MME, and the SGW/PGW). Network re-engineering/re-planning would be required to cope with mMTC devices since, according to several deployment models, mMTC devices are expected to outnumber of several order of magnitude smartphones and data cards.

The always on concept presumes the UE, while attached, will require frequent data exchange, this justifying the permanent allocation of resources to support the default bearer. This assumption is likely to be wrong for mMTC, for which small and infrequent data transmission appear to be the dominant model.

Current enhancements for mMTC still assume a mMTC device to be treated as a UE, i.e. still relying on the “bearer” and the “always on” concepts, although procedures and timers are being updated to fit with expected device behaviours adhering to the small and infrequent traffic model.

US 20130301611 A1 discloses a method and system for uplink-downlink transmission of data packets in a wireless cellular network, during UE idle state, using connectionless transmission. The method directly refers to the EPS system, and it proposes to establish a S1 common bearer between a Radio Access Network (RAN) node and Serving Gateway (SGW) and a S5 common bearer between the SGW and Packet Data Network Gateway (PGW). The method also defines a modified Uu interface between the UE and the RAN node. The method appends to data packets a UE Identifier (ID) and routing information as packet header information to independently route data packets through a wireless cellular network. The method secures data packets by providing integrity and ciphering protection. The method avoids dedicated bearer set up and reduces signaling overhead on the Uu interface thereby improving network efficiency and battery life of the UE.

WO2014186935 A1 addresses the problem of small data transmission efficiency in an EPS system from a data plane perspective. In LTE/EPC IP-based EPS systems, data suffer from overhead due to IP/GTP-U encapsulation, resulting in a substantial data plane inefficiency for small data transmission. WO2014186935 A1 discloses a data transmission method, device and system, comprising: 1) detecting the type of data contained in a received GTP-U data packet; 2) if the type matches a given condition, decapsulating the GTP-U data packet to obtain the data and the destination address, 3) sending the data and the destination address to a message gateway, so that 4) the message gateway forwards the data of the target type (i.e. the one matching the condition) according to the destination address.

The paper “Connection-less communication of IoT devices over LTE mobile networks” by R. Piqueras Jover and I. Murynets, Sensing, Communication, and Networking (SECON), 2015 12th Annual IEEE International Conference, Seattle, Wash., 2015, pp. 247-255, proposes a connection-less communication protocol for IoT devices over LTE mobile networks which requires no control plane signaling at the EPC. This technique is specifically designed for M2M embedded devices with low throughput and delay tolerant traffic, which often are the worst case scenario in terms of signaling load at the EPC. The approach reduces signaling but does not support QoS. As a potential alternative, the paper also mentions the possibility to set and maintain a perpetual bearer between the eNB and the PGW. All the connection-less traffic originating at or terminating at M2M connected devices camped on a given cell would then be routed through that always-on bearer to the P-GW, where firewall, NAT (Network Address Translation) and other security functions are executed in a standard LTE architecture.

Another proposal for a connectionless access method for efficient small burst transmission for cellular networks is presented in the paper “Connectionless Access for Mobile Cellular Networks” by C Kahn and H. Viswanathan, in IEEE Communications Magazine, vol. 53, no. 9, pp. 26-31, September 2015. The paper proposes a new protocol for connectionless access aiming at reducing over-the-air signaling. The focus is not on the core network.

WO2014047920 A1 discloses a method to transmit uplink small data via the control plane. According to this proposal, the base station sends the uplink data to an MME by using a signaling message between the base station and the MME. The MME further sends the uplink data to a corresponding application server by using a signaling message between the MME and a P-CSCF. The method avoids using D-plane bearers for connection-less communication. It is, however, not suitable for massive MTC type of communications, because the huge amount of small data may overload the control plane and degrade the overall system performance.

Thus, there is a need for improved devices and methods for session management in a communication network, in particular a 5G network.

### SUMMARY

It is an object of the invention to provide for improved devices and methods for session management in a communication network, in particular a 5G network.

The foregoing and other objectives are achieved by the subject matter of the independent claims. Further implementation forms are apparent from the dependent claims, the description and the figures.

Embodiments of the invention are based on a new connection oriented connectivity model for next generation networks customized to support, in particular, static mMTC services. Embodiments of the invention provide mMTC tailored architectures and Control plane/Data plane procedures compliant to the network slicing concept, in order to guarantee an efficient mMTC support in future 5G systems, in particular an efficient session management for mMTC. More specifically, embodiments of the invention address Core Network Control and Data plane issues, which will arise due to the massive number of communication devices requiring connectivity in future 5G networks.

Thus, according to a first aspect the invention relates to a control plane, CP, network entity configured to manage communication between an access network, AN, and a core network, CN, of a communication system, wherein the CP network entity comprises a processor configured, in response to a connectivity request from a first physical device, to assign the first physical device to a virtual device and to establish an aggregate CN bearer for the virtual device. In an embodiment based on EPS, the aggregate CN bearer comprises a S1 bearer and a S5/S8 bearer.

Thus, an improved CP network entity for session management in a communication network, in particular a 5G network is provided.

In a first implementation form of the CP network entity according to the first aspect as such, the processor is configured to provide a virtual address VD ADD to the virtual device, when assigning the first physical device to the virtual device.

In a second implementation form of the CP network entity according to the first aspect as such or the first implementation form thereof, the processor is configured to provide a physical device tag PD TAG and to assign the physical device tag PD TAG to the first physical device for identifying the first physical device as part of the virtual device.

In a third implementation form of the CP network entity according to the second implementation form of the first aspect, the first physical device is associated with a device identifier and a device class parameter and wherein the physical device tag PD TAG is based on the hash value of a combination, in particular a concatenation, of the device identifier and the device class parameter of the first physical device. The device class parameter can define the mMTC requirements. The virtual device belongs to the same device class as the physical devices assigned thereto. Thus, the concept of an aggregate CN bearer allows handling of data generated/directed to the physical devices in compliance with requirements defined for the device class these physical devices and the associated virtual device belong to.

In a fourth implementation form of the CP network entity according to the first aspect as such or any one of the first to third implementation form thereof, the processor is configured to allocate an access CN bearer identifier to the access CN bearer of the virtual device.

In a fifth implementation form of the CP network entity according to the first aspect as such or any one of the first to fourth implementation form thereof, the first physical device is associated with a first device class parameter and wherein the processor is configured, in response to a connectivity request from a second physical device, to assign the second physical device to the virtual device, in case a second device class parameter associated with the second physical device is identical to the first device class parameter of the first physical device, or, in case the second device class parameter associated with the second physical device differs from the first device class parameter of the first physical device, to assign the second physical device to a further virtual device and to establish a further aggregate CN bearer for the further virtual device.

In a sixth implementation form of the CP network entity according to the fifth implementation form of the first aspect, the processor is configured, in response to the connectivity request from the second physical device, to assign the second physical device to a further virtual device and to establish a further aggregate CN bearer for the further virtual device, in case the second device class parameter associated with the second physical device is identical to the first device class parameter of the first physical device and the number of physical devices already assigned to the first virtual device is equal to or larger than a parameter defining the maximum number of physical devices per virtual device.

In a seventh implementation form of the CP network entity according to the sixth implementation form of the first aspect, the processor is configured to use different parameters defining the maximum number of physical devices per virtual device for different device classes.

In an eighth implementation form of the CP network entity according to the seventh implementation form of the first aspect, the processor is configured to dynamically adjust the parameters defining the maximum number of physical devices per virtual device.

In a ninth implementation form of the CP network entity according to the first aspect as such or any one of the first to eighth implementation form thereof, the processor is configured to remove the aggregate CN bearer for the virtual device, in case the first physical device and any other physical device assigned to the virtual device have not been active for a time period, which is equal to or larger than an inactivity time period.

In a tenth implementation form of the CP network entity according to the ninth implementation form of the first aspect, the processor is configured to remove the aggregate CN bearer for the virtual device, in response to a message from an AN entity indicating that the first physical device and any other physical device assigned to the virtual device have not been active for a time period, which is equal to or larger than the inactivity time period.

In an eleventh implementation form of the CP network entity according to the first aspect as such or any one of the first to tenth implementation form thereof, the first physical device is associated with a device class parameter and the processor is configured to establish the aggregate CN bearer for the virtual device on the basis of the device class parameter of the first physical device. In other words, the CP network entity can be configured to establish the aggregate CN bearer in accordance with requirements defined by the device class of the virtual device and the physical devices associated therewith. In an implementation form the device class of the virtual device and the physical devices associated therewith can define one or more of the following requirements: a QoS profile, minimum reliability, minimum availability, supported PDN, PDN specific requirements and the like.

In a further implementation form of the CP network entity according to the first aspect as such or any one of the first to eleventh implementation form thereof, the CP network entity is implemented as a mobility management entity (MME).

Thus, the CP network entity according to the first aspect and its different implementation forms allows defining virtual devices composed of the aggregation of a plurality of physical devices camped on the same cell and belonging to the same device class. The concept of a virtual device as implemented in embodiments of the invention allows the core network and, in particular, the CP network entity to handle the multitude of physical devices as if they were a single (virtual) device. Moreover, the CP network entity according to the first aspect and its different implementation forms allows providing aggregate CN bearers spanning from an AN entity, such as a evolved node B, to a DPG network entity of the core network, such as a SGW, PGW or a combination thereof, wherein each aggregate CN bearer is associated with a virtual device, for transporting data generated by all physical devices being associated with a virtual device from the AN entity to the DPG network entity and vice versa. In embodiments of the invention the CP network entity can assign one of two states to each physical device, namely “Device Connected” or “Device Not Connected”. In embodiments of the invention, the state of a physical device is the same as the state of the virtual device, which the physical device is assigned to. In embodiments of the invention, the state of a virtual device can be Device Connected” or “Device Not Connected”.

Embodiments of the invention are compliant with both connectionless and connection-oriented methods supported by the AN. For embodiments where the Access Network supports a connection-oriented method, i.e. it supports the equivalent of an EPS radio bearer, the aggregate CN bearer leads to a one-to-many mapping between an aggregate CN bearer and the radio bearers.

According to a second aspect the invention relates to a communication system comprising a CP network entity according to the first aspect as such or any one of the first to eleventh implementation form thereof, in communication with an AN entity, in particular an evolved node B, and a DPG network entity, in particular a SGN, a PGN or a combination thereof.

According to a third aspect the invention relates to a method of operating a control plane, CP, network entity configured to manage communication between an access network, AN, and a core network, CN, of a wireless communication system, wherein the method comprises the steps of: assigning, in response to a connectivity request from a first physical device, the first physical device to a virtual device; and establishing an aggregate CN bearer for the virtual device.

The method according to the third aspect of the invention can be performed by the CP network entity according to the first aspect of the invention. Further features of the method according to the third aspect of the invention result directly from the functionality of the CP network entity according to the first aspect of the invention and its different implementation forms.

According to a fourth aspect the invention relates to a computer program comprising program code for performing the method according to the third aspect of the invention when executed on a computer.

The invention can be implemented in hardware and/or software.

### BRIEF DESCRIPTION OF THE DRAWINGS

Further embodiments of the invention will be described with respect to the following figures, wherein:

FIG. 1 shows a schematic diagram illustrating the bearer service architecture for 4G networks;

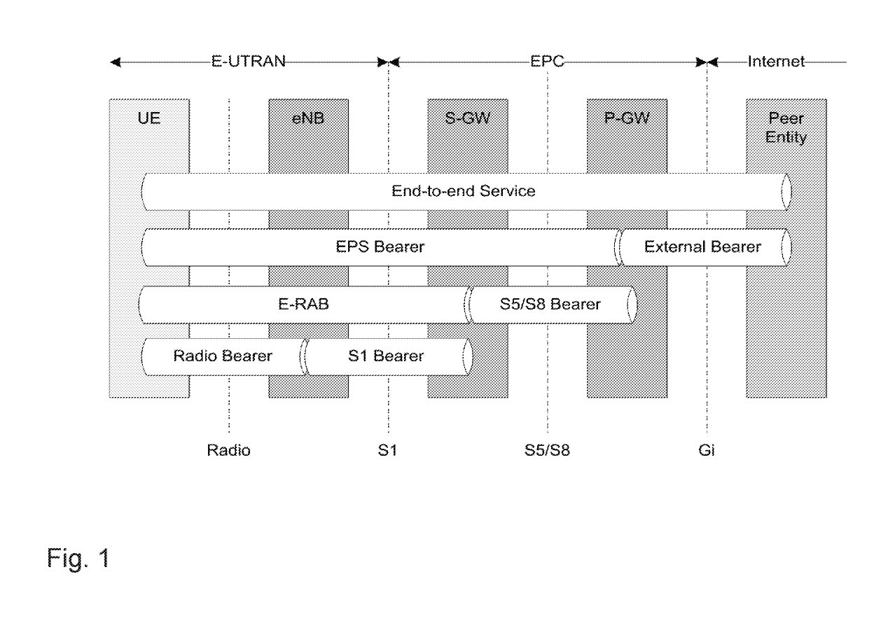

FIG. 2 shows a schematic diagram illustrating the EPS bearer composition for 4G networks;

FIG. 3 shows a schematic diagram illustrating a communication system comprising a network entity according to an embodiment;

FIG. 4 shows a schematic diagram illustrating an early bird physical device connectivity establishment procedure according to an embodiment;

FIG. 5 shows a schematic diagram illustrating a late physical device connectivity establishment procedure according to an embodiment;

FIG. 6 shows a schematic diagram illustrating the transmission of data from a physical device being associated with a virtual device to the network according to an embodiment;

FIG. 7 shows a schematic diagram illustrating the transmission of data from the network to a physical device being associated with a virtual device according to an embodiment;

FIG. 8 shows a schematic diagram illustrating a virtual device disconnection procedure according to an embodiment;

FIG. 9 shows a schematic diagram illustrating control plane and data plane protocol stacks according to an embodiment;

FIG. 10a shows a schematic diagram illustrating exemplary downlink packet structures according to an embodiment;

FIG. 10b shows a schematic diagram illustrating exemplary uplink packet structures according to an embodiment; and

FIG. 11 shows a schematic diagram illustrating a method of operating a network entity according to an embodiment.

In the figures, identical reference signs will be used for identical or functionally equivalent features.

### DETAILED DESCRIPTION OF EMBODIMENTS

In the following description, reference is made to the accompanying drawings, which form part of the disclosure, and in which are shown, by way of illustration, specific aspects in which the present invention may be placed. It will be appreciated that the invention may be placed in other aspects and that structural or logical changes may be made without departing from the scope of the invention. The following detailed description, therefore, is not to be taken in a limiting sense, as the scope of the invention is defined by the appended claims.

For instance, it will be appreciated that a disclosure in connection with a described method will generally also hold true for a corresponding device or system configured to perform the method and vice versa. For example, if a specific method step is described, a corresponding device may include a unit to perform the described method step, even if such unit is not explicitly described or illustrated in the figures.

Moreover, in the following detailed description as well as in the claims, embodiments with functional blocks or processing units are described, which are connected with each other or exchange signals. It will be appreciated that the invention also covers embodiments which include additional functional blocks or processing units that are arranged between the functional blocks or processing units of the embodiments described below.

Finally, it is understood that the features of the various exemplary aspects described herein may be combined with each other, unless specifically noted otherwise.

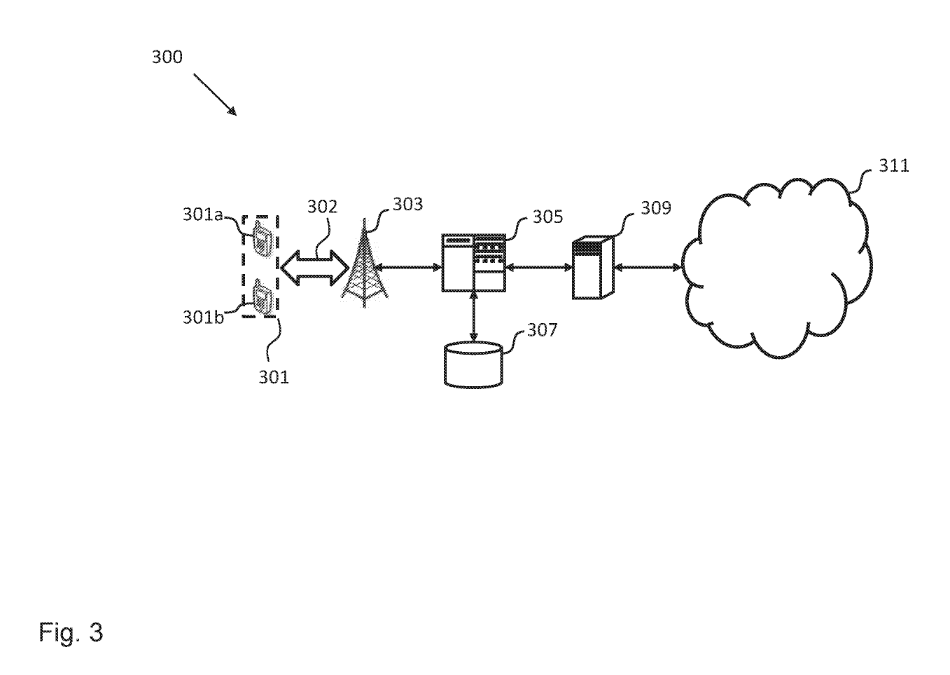

FIG. 3 shows a schematic diagram illustrating a communication system 300 according to an embodiment. In an embodiment, the communication system is a 5G network or part thereof.

In the embodiment shown in FIG. 3, the communication system 300 comprises a first user equipment (UE) 301a and a second user equipment (UE) 301b, which are configured to communication via an air or radio interface 302 with an access network (AN) entity in the form of a base station 303 of the communication system 300. In an embodiment, the AN entity 303 is an evolved Node B (eNB). The AN entity 303 is configured to handle control plane (CP) and data plane (DP) traffic at the access network. As will be appreciated, the user equipments 301a and 301b are exemplary representatives of a plurality of user equipments within the network cell established by the AN entity 303. This plurality of user equipments can comprise sensors, meters, actuators and similar devices requiring connectivity.

Furthermore, the communication system 300 comprises a network entity 305 configured to perform control plane (CP) functions (herein referred to as CP network entity 305) at the core network, a network entity 307 configured to perform authorization, authentication and/or accounting (AAA) functions (herein referred to as AAA network entity 307) as well as a network entity 309 configured to perform data plane gateway functions at the core network (herein referred to as DPG network entity 309) for communication with a data packet network (DPN) 311. In an embodiment, the CP network entity 305 is a mobility management entity (MME) according to the 3GPP standard. In an embodiment, the AAA network entity 307 is a home location register (HLR) according to the 3GPP standard. In an embodiment, the DPG network entity 309 is a serving gateway (SGW) according to the 3GPP standard, a PDN gateway (PGW) according to the 3GPP standard or a combination thereof. In an embodiment, the AN entity 303, the CP network entity 305, the AAA network entity 307 and/or the DPG network entity 309 can at least partially be implemented as logical elements and/or functions of a physical network infrastructure, for instance as network functions provided by software implemented on a physical network infrastructure.

As indicated in FIG. 3 and as will be described in the following in the context of the additional figures, in embodiments of the invention the first user equipment 301a and the second user equipment 301b (which will be also referred to as first physical device PhD1 and second physical device PhD2) are treated as a single virtual device (ViD 1) 301, in particular by the CP network entity 305.

As will be appreciated from the following, embodiments of the invention are particularly beneficial for user equipments in form of static mMTC physical devices, such as smart sensors, smart meters, smart actuators and the like. In an embodiment, each physical device 301a, 301b can have a unique device identifier (Device ID). In an embodiment, the device data can be end to end encrypted. In an embodiment, there can be no state definition on the AN entity 303 and/or the CP network entity 305. In an embodiment, only a “Connected” or “Not Connected” state is defined for the physical devices 301a, 301b and the virtual device 301.

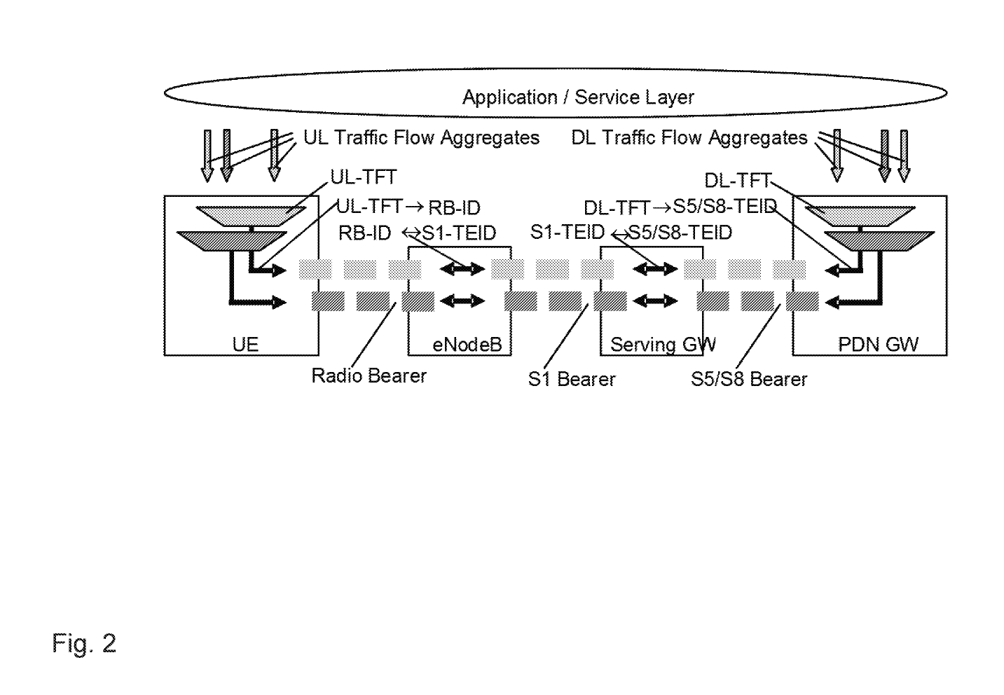

For the description of the following embodiments in the context of FIGS. 2 to 11 it is assumed that the communication system 300 shown in FIG. 3 is based on a 5G network architecture. It will be appreciated, however, that the embodiments of the invention can be implemented in communication systems or networks based on a different architecture as well, where the functions described below might be provided by different network entities.

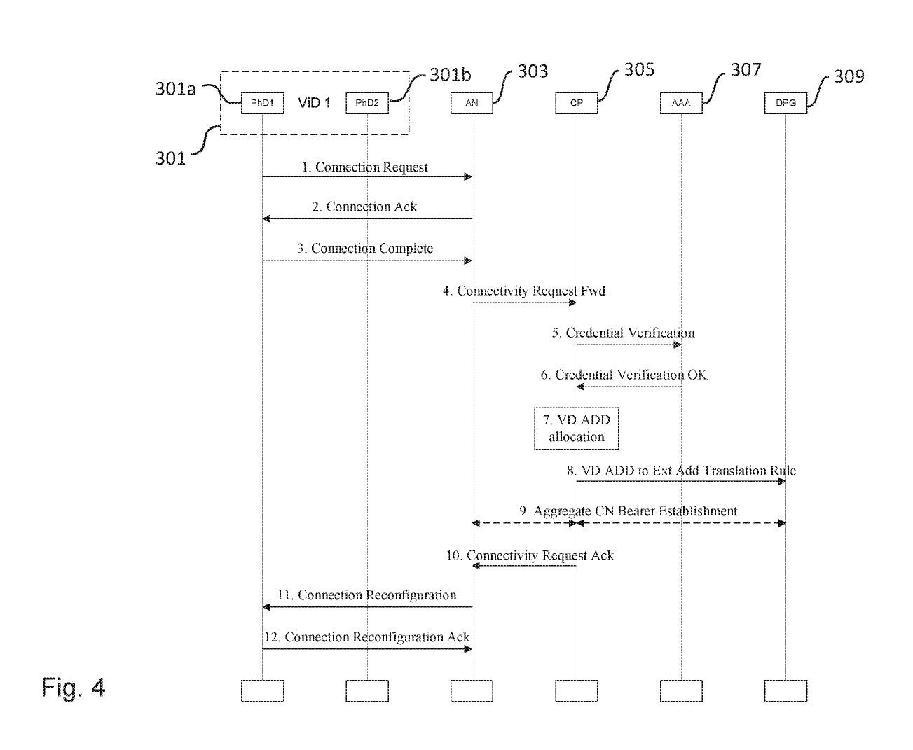

FIG. 4 shows an embodiment of a connectivity establishment procedure, which can be used for establishing connectivity in the following scenario. The first and the second physical device 301a, 301b have not attempted any connectivity request via the AN entity 303 yet. No virtual devices, such as the virtual device 301, are connected yet. The first physical device (PhD1) 301a is switched on, is in the “Not Connected” state and requires connectivity to the data packet network 311. As in this scenario no physical devices are connected yet, the first physical device 310a, which triggers the connectivity establishment procedure shown in FIG. 4, will also be referred to as early bird physical device 301a.

In an embodiment, the first physical device 301a and the second physical device 301b belong to the same device class. Exemplary device classes are “smart sensors”, “smart meters” and the like. In an embodiment, the device class of the first and second physical device 301a, 301b is defined by a respective device class identifier (Device Class).

In a first step of FIG. 4 the first physical device (PhD1) 301a, i.e. the early bird physical device, sends a “Connection Request” message to the AN entity 303.

In a second step of FIG. 4 the AN entity 303 sends a “Connection Ack” message to the first physical device 301a.

In a third step of FIG. 4 the first physical device 301a sends a “Connection Complete” message to the AN entity 303. The “Connection Complete” message contains the “Connectivity Request” message to be forwarded to the CP network entity 305. The “Connectivity Request” message carries information including (but not limited to) Device ID, Device Class, mMTC PDN ID (i.e. Massive Machine Type Communication Packet Data Network ID).

In a fourth step of FIG. 4 the AN entity 303 sends a “Connectivity Request Forward” message to the CP network entity 305.

In a fifth step of FIG. 4 the CP network entity 305 sends a “Credential Verification” message to the AAA network entity 307, including, for instance, Device ID, Device Class, and mMTC PDN ID.

In a sixth step of FIG. 4 the AAA network entity 307 sends a “Credential Verification OK” message to the CP network entity 305.

As no virtual device for the device class of the first physical device 301a is connected, i.e. has been instantiated yet, the CP network entity 305 allocates a new virtual device address “VD ADD” and a physical device tag or identifier “PD TAG” to the first physical device 301a, i.e. the early bird physical device 301a. In doing so, the CP network entity 305 so to say creates the virtual device (ViD1) 301, because the new virtual device address “VD ADD” uniquely identifies the virtual device (ViD1) 301 within the network. In an embodiment, the CP network entity is configured to generate the physical device tag “PD TAG” of the first physical device 301a by computing the hash value of a concatenation Device ID and Device Class. The physical device tag “PD TAG” uniquely identifies the first physical device 301a within the virtual device 301.

In an eighth step of FIG. 4 the CP network entity 305 sends a “VD ADD to Ext ADD Mapping Rule” message to the DPG network entity 309, defining a mapping rule and thereby allowing the DPG network entity 309 to map the virtual address VD ADD to external network addresses.

In a ninth step of FIG. 4 the CP network entity 305 establishes an aggregate CN bearer between the AN entity 303 and the DPG network entity 309 to the selected mMTC PDN 311. The aggregate CN bearer is identified by an access CN bearer ID (ACNB_ID) identifier, which is allocated by the CP network entity 305. In the context of establishing the aggregate CN bearer, the CP network entity 305 configures the AN entity 303 and the DPG network entity 309 for a proper treatment of data carried over the bearer according to the required QoS for the Device Class indicated by the “Connectivity Request” message. In an embodiment, the aggregate CN bearer can comprise a S1 bearer and a S5/S8 bearer.

In a tenth step of FIG. 4 the CP network entity 305 sends a “Connectivity Request Ack” message to the AN entity 303, including the following data: Device ID, Physical Device Class, mMTC PDN ID, VD ADD, PD TAG.

In an eleventh step of FIG. 4 the AN entity 303 sends a “Connection Reconfiguration” message to the first physical device 301a, encapsulating the “Connectivity Request Ack” message.

In a twelfth step of FIG. 4 the first physical device sends 301a the “Connection Reconfiguration Ack” message to the AN entity 303.

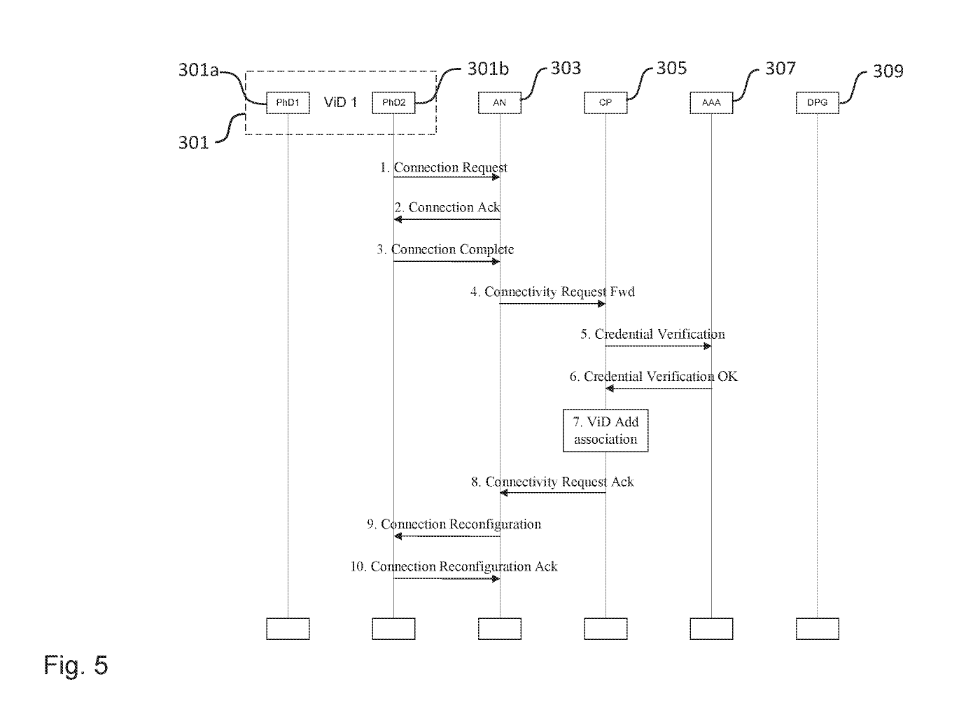

Thus, as a result of the procedure shown in FIG. 4, the first physical device 301a and the virtual device 301 (at least from the perspective of the CP network entity 305) are now “connected” to the network. When the second physical device 301b, belonging to the same Device Class as the first physical device 301a, is subsequently switched on and requires connectivity, the procedure depicted in FIG. 5 can be carried out in order to connect the second physical device 301b, which is also referred to as late physical device 301b.

In a first step of FIG. 5 the second physical device 301b, i.e. the late physical device, sends a “Connection Request” message to the AN entity 303.

In a second step of FIG. 5 the AN entity 303 sends a “Connection Ack” message to the second physical device 30 lb.

In a third step of FIG. 5 the second physical device 301b sends a “Connection Complete” message to the AN entity 303, encapsulating the Connectivity Request (Device ID, Device Class, mMTC PDN ID . . . ).

In a fourth step of FIG. 5 the AN entity 303 sends a “Connectivity Request Forward” message to the CP network entity 305.

In a fifth step of FIG. 5 the CP network entity 305 sends a “Credential Verification” message to the AAA network entity 307 (Device ID, Device Class, mMTC PDN ID . . . ).

In a sixth step of FIG. 5 the AAA network entity 303 sends a “Credential Verification OK” message to the CP network entity 305.

As the virtual device 301 is already connected for the Device Class the second physical device 301b belongs to and as the number of physical devices associated to the virtual device 301 does not exceed a pre-definable parameter for the maximum number of physical devices per virtual device (herein also referred to as “Maximum Number of Physical Devices per Virtual Device parameter”), the CP network entity 305 in step 7 of FIG. 5 associates the virtual device address VD ADD, which is allocated to all physical devices of the same Device Class, such as the first or early bird physical device 301a, to the second or late physical device 301b and allocates a Physical Device Tag PD TAG (hash of Device ID+Physical Device Class) to the second physical device 301b.

According to an embodiment, the CP network entity 305 is configured to allocate a new virtual device address VD ADD to the second physical device 301b (and thereby create a new virtual device), if the number of physical devices associated to the virtual device 301 exceeds the Maximum Number of Physical Device per Virtual Device parameter. In an embodiment, the parameter defining the maximum number of physical devices per virtual device can have a value of 10, 100, 1000 or 10000.

In an eighth step of FIG. 5 the CP network entity 305 sends a “Connectivity Request Ack” message to the AN entity 303, including Device ID, Device Class, mMTC PDN ID, VD ADD, PD TAG.

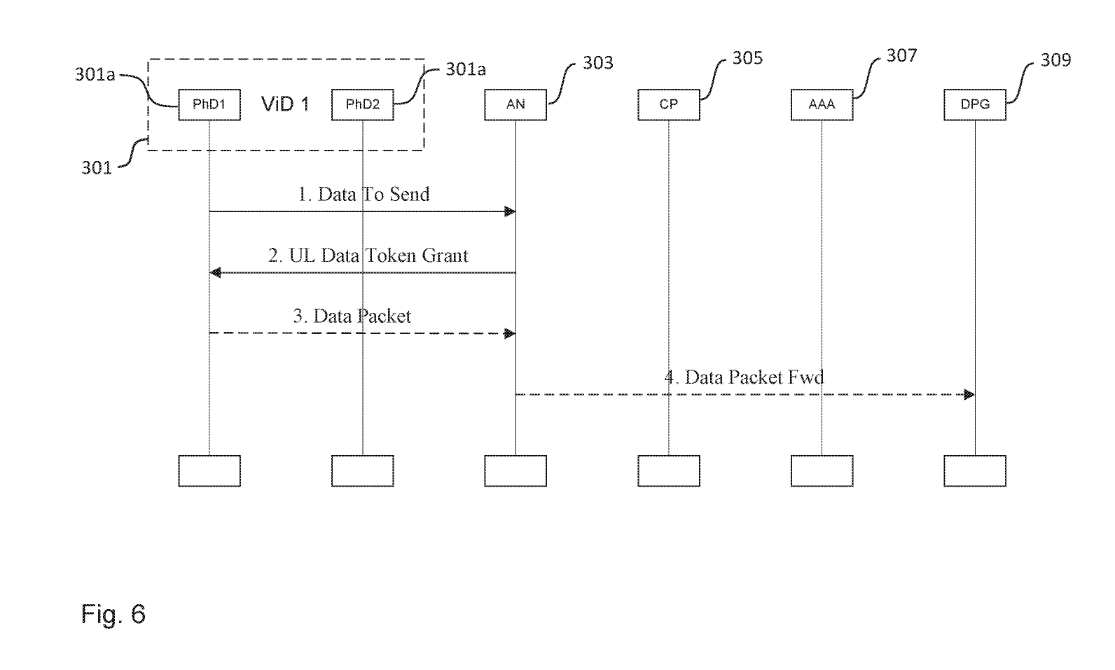

In a ninth step of FIG. 5 the AN entity 303 sends a “Connection Reconfiguration” message to the second physical device 301b, encapsulating the “Connectivity Request Ack” message. This message allows delivering to the second physical device 301b the “Connectivity Request Ack” message as well as notifying the second physical device 301b that its request has been accepted and that it is now connected. A similar message might be provided to reconfigure the radio connection. In a tenth step of FIG. 5 the second physical device 301b, which is now part of the virtual device 301, sends a “Connection Reconfiguration Ack” message to the AN entity 303. As the virtual device 301 comprising the first physical device 301a and the second physical device 301b is now “connected” to the network, the situation may arise that the first physical device 301a and/or the second physical device 301b may need to send data to the PDN 311. In an embodiment, the physical devices 301a, 301b may need to send data asynchronously. FIG. 6 shows the procedure according to an embodiment for transmitting data from the first physical device 301a to the mMTC PDN 311 it is connected to.

In a first step of FIG. 6 the first physical device 301a sends a “Data To Send” message to the AN entity 303 in order to indicate that it wants to send data to the PDN 311.

In response thereto, the AN entity 303 sends in a second step of FIG. 6 a UL Data Token Grant to the first physical device 301a.

On the basis of the UL Data Token Grant the first physical device 301a sends in a third step of FIG. 6 a Data Packet message to the AN entity 303 including the data payload, the virtual address assigned to the virtual device 301 the first physical device 301a belongs to, i.e. VD ADD, and the tag assigned to the first physical device 301a, i.e. PD TAG. This message is forwarded by the AN entity 303 via the aggregate CN bearer assigned to the virtual device 301 to the DPG network entity 309 and the PDN 311.

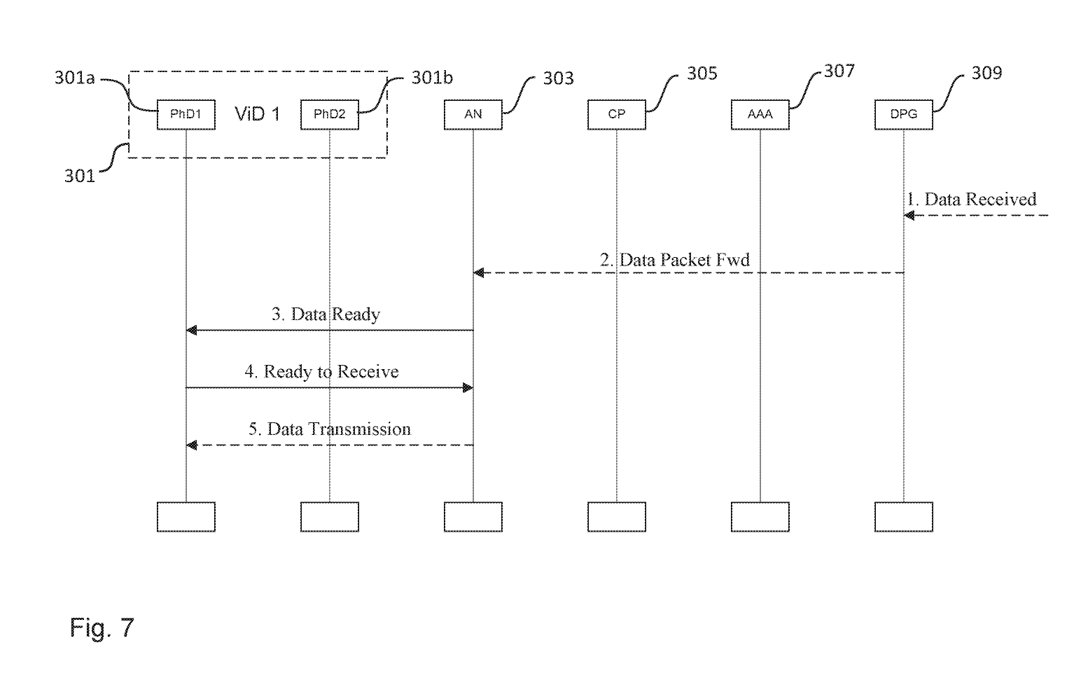

While the procedure shown in FIG. 6 concerns the transmission of data from the physical devices 301a, 301b, FIG. 7 shows an embodiment of an procedure for transmitting data from the PDN 311, e.g. from a mMTC server connected to the PDN 311, to one of the physical devices 301a, 301b belonging to the virtual device 301. By way of example, in FIG. 7 it is assumed that the data is send to the first physical device 301a.

In a first step of FIG. 7 a “Data Packet” message is received at the DPG network entity 309. In an embodiment, the DPG network entity 309 is configured to translate the destination address of the “Data Packet” message using the VD ADD to Ext Add Translation Rule. The destination address included in the “Data Packet” message is converted into the virtual address VD ADD and the physical device tag PD Tag for identifying the virtual device 301 and the first physical device 301a.

In a second step of FIG. 7 the DPG network entity 309 sends the “Data Packet Forward” message, (encapsulating the Data Packet) via the aggregate CN bearer to the AN entity 303.

In a third step of FIG. 7 the AN entity 303 sends a “Data Ready” message to the first physical device 301a to wake it up. This message acts as “device wake up” signaling, allowing support of low power devices.

In a fourth step of FIG. 7 the first physical device 301a sends a “Ready To Receive” message to the AN entity 303.

In a fifth step of FIG. 7 the AN entity 303 sends the “Data Transmission” message to the first physical device 301a, encapsulating the data packet.

According to an embodiment, the CP network entity 305 is configured to disconnect or release the virtual device 301, when the AN entity 303 detects an extended inactivity by all physical devices, which are associated with or assigned to the virtual device 301, such as, for instance, the first physical device 301a and the second physical device 301b. Such an embodiment allows saving network resources. In an embodiment, the CP network entity 305 is configured to disconnect the virtual device 301, when the AN entity 303 detects no activity of any physical device associated with the virtual device 301 over a time period which is longer than a predefined inactivity time.

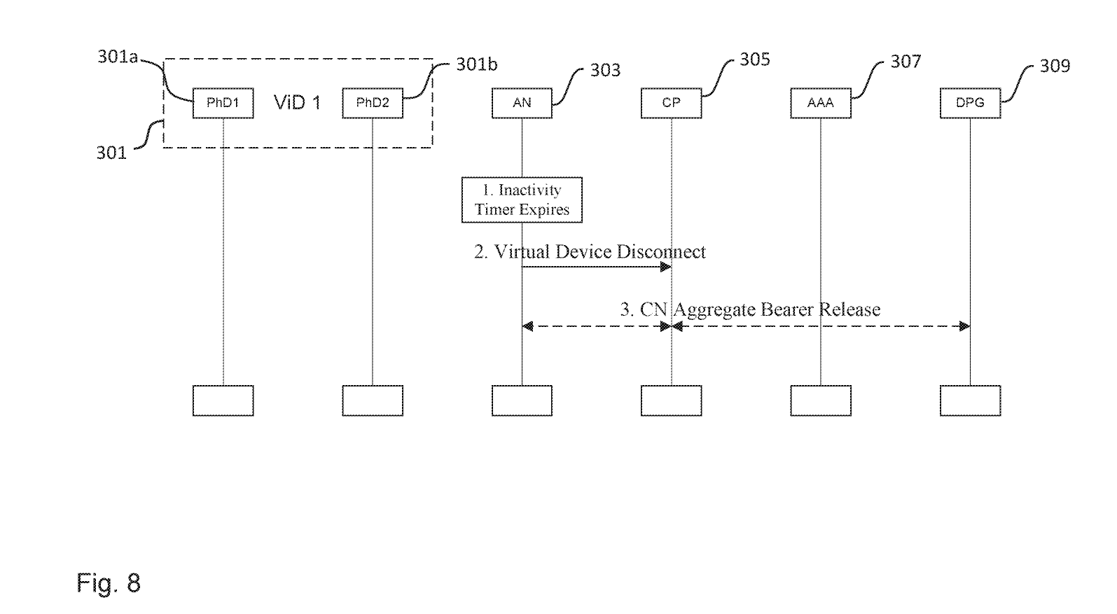

An embodiment of a procedure for disconnecting the virtual device 301 is shown in FIG. 8.

The Inactivity Time Expires event manifests inactivity by all physical devices associated with the connected virtual device 301 (first step of FIG. 8).

This triggers the AN entity 303 to send a “Virtual Device Disconnect” message to the CP network entity 305 in a second step of FIG. 8.

In response thereto, the CP network entity 305 executes an aggregate CN bearer release procedure towards the AN entity 303 and the DPG network entity 311. The aggregate CN bearer release procedure performs the de-allocation of virtual device context resources kept at the AN entity 303 and the DPG network 311 as well as the de-allocation of network resources associated to the aggregate CN bearer to fulfill QoS requirements in compliance with the device class.

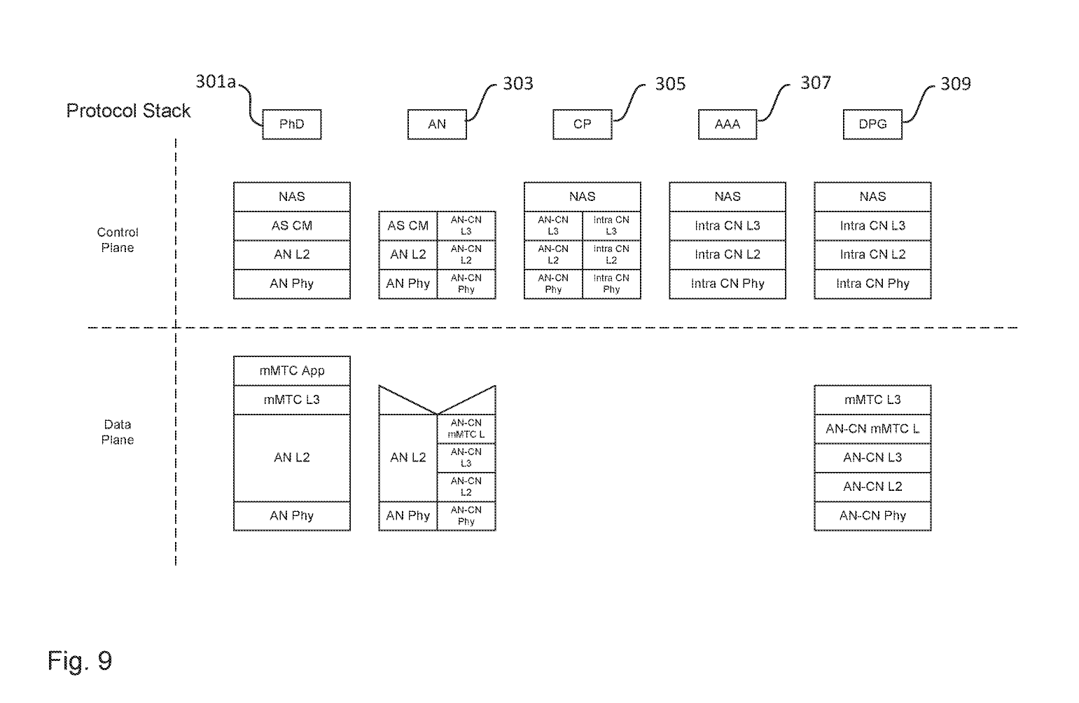

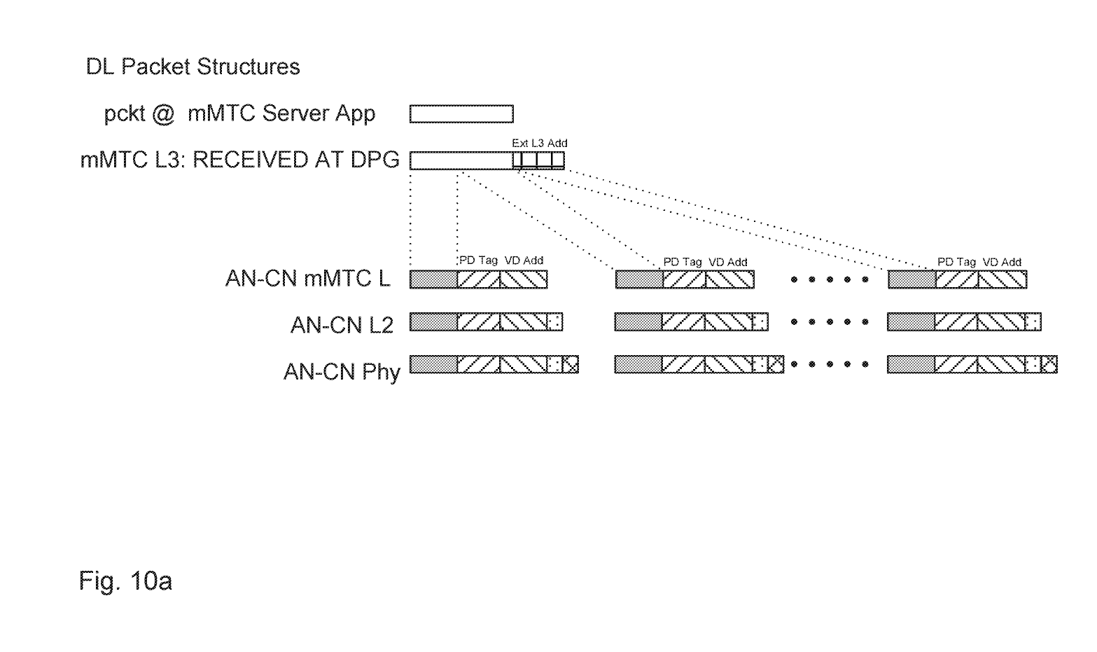

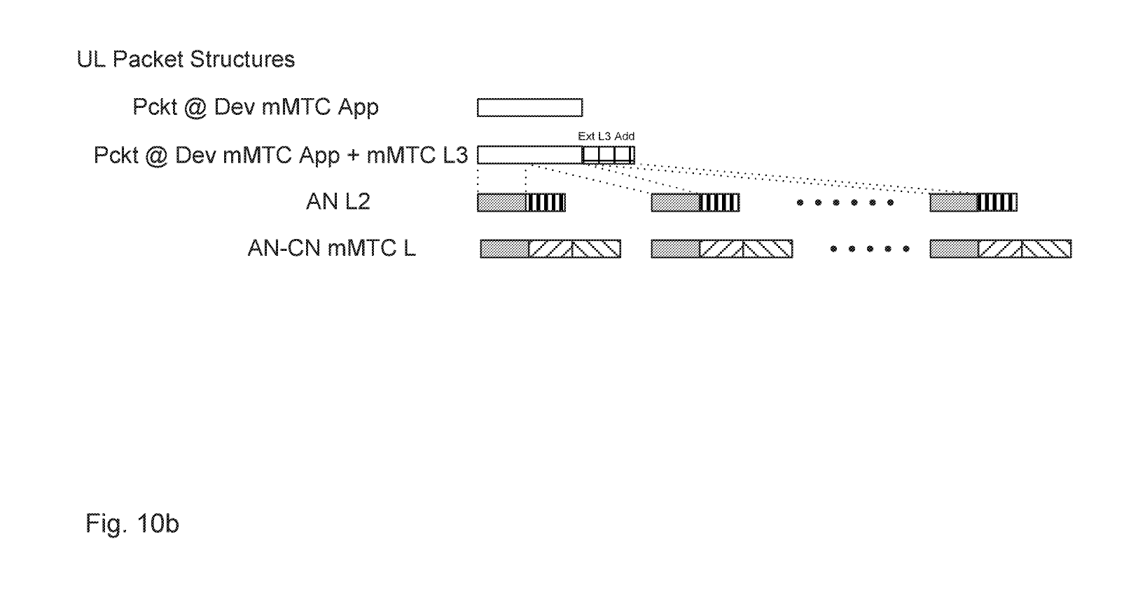

FIGS. 9, 10a and 10b illustrate protocol stacks and packet formats that can be used in embodiments of the invention. As can be taken from these figures, in an embodiment, the virtual device address VD ADD and the physical device tag PD TAG can be defined by the CP network entity 305 as a function of the allocated Ext L3 Address, wherein its specific type and format depends on the addressing scheme required by the mMTC service. In an embodiment, the Ext L3 Address may be based on IPv4, IPv6, or another addressing scheme customised for mMTC.

More specifically, FIG. 9 shows a possible embodiment of the protocol stack for the devices and entities described above, namely PhD, AN, CP, AAA and DPG, for both the control plane and data plane. FIG. 10a schematically represents a possible embodiment of the DownLink Data Packet structure. The picture shows the data packet generated by a mMTC server application, and the data packet received at the DPG network entity 309, which is the data packet generated by the mMTC server application plus an external L3 address (Ext L3 Add). Moreover, FIG. 10a also shows how the data packet received at the DPG network entity 309 may be fragmented, according to an embodiment, before being sent through the aggregate CN bearer, and how each fragment can be associated to a virtual address VD Add and a physical device tag PD Tag. Similarly, FIG. 10b schematically represents a possible embodiment of the Uplink Data Packet structure.

As already described above, according to an embodiment the CP network entity 305 is configured to allocate a virtual device address VD ADD to a virtual device, such as the virtual device 301. According to an embodiment, the rules and policies about how to map a physical device to a virtual device can be preconfigured in the CP network entity 305. According to an embodiment, such rules and policies can also be provided by a third party service provider.

As already described above, the CP network entity 305 can be configured to allow only a maximum number of physical devices to be associated with a virtual device. In an embodiment, the maximum number of physical devices can be different for different device classes. For instance, the maximum number of physical devices of a virtual device for the device class “smart meters” can be smaller than the maximum number of physical devices of a virtual device for the device class “smart sensors”. In an embodiment, the CP network entity 305 is configured to be able to dynamically adjust the maximum number of physical devices to be associated with a virtual device, for instance, in response to changing network conditions. In an embodiment, the maximum number of physical devices to be associated with a virtual device can depend on the bandwidth allocated to the aggregate CN bearer, the current bandwidth used by the aggregate CN bearer or similar parameters. As already described above, the CP network entity 305 allows to handle one or more virtual devices camped on the same cell (associated with the AN entity 303) and belonging to the same device class.

As already described above, the number of physical devices that belong to the same virtual devices can increase or decrease, for instance, new physical devices may join an already existing virtual device or leave the virtual device, for instance due to power on or power off. If a physical device is located at the edge of a cell, it may select different cells at different times, for instance, due to a transmission power adjustment from neighboring cells. Therefore, physical devices may leave one virtual device and join another virtual device.

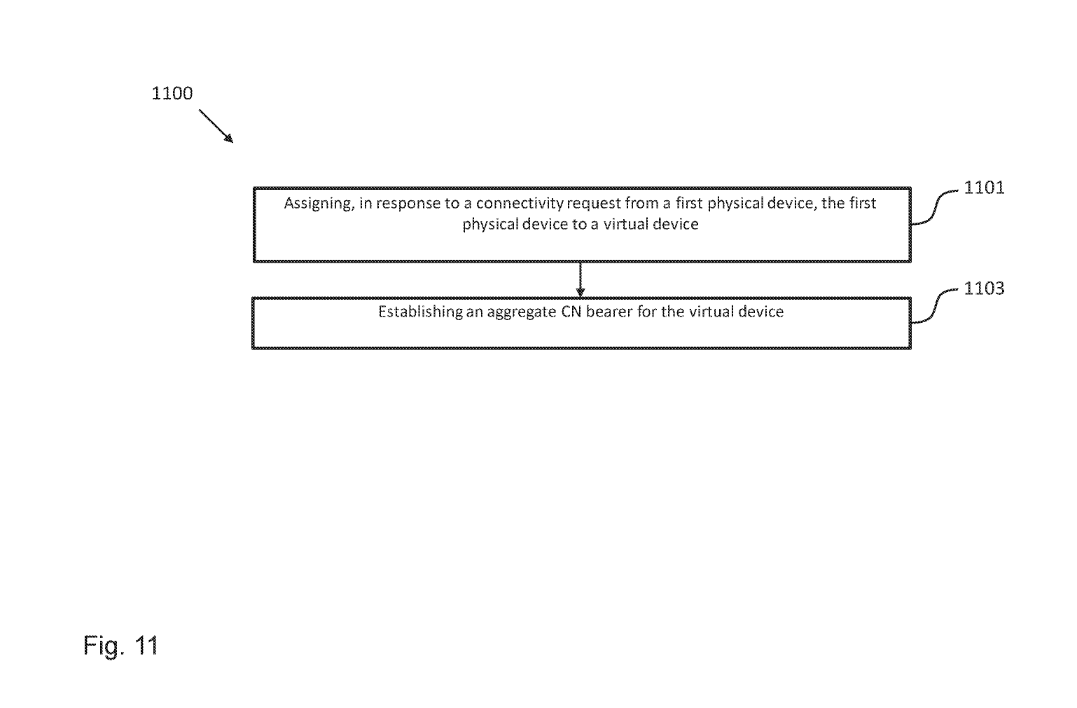

FIG. 11 shows a schematic diagram illustrating a method 1100 of operating the CP network entity 305 according to an embodiment. The method 1100 comprises a step 1101 of assigning, in response to a connectivity request from the first physical device (301a), the first physical device (301a) to the virtual device (301) and a step 1103 of establishing an aggregate CN bearer for the virtual device (301).

Embodiments of the invention provide, amongst others, for the following advantages.

Embodiments of the invention allow simplifying the CN CP state machine. This is because, embodiments of the invention, which are particularly suited to support static mMTC devices, do not require all mobility related states at the core network.

Embodiments of the invention allow reducing the CN CP signaling. This is because, embodiments of the invention, which are particularly suited to support static mMTC devices, do not require dedicated bearers for each physical device by establishing only one CN bearer per virtual device.

Embodiments of the invention allows to support QoS and traffic segregation will be supported at the CN side, providing a benefit in comparison to connectionless solutions aiming at CP signaling reduction.

Embodiments of the invention allow to provide a guaranteed QoS at the AN entity 303. As the connectivity model implemented in embodiments of the invention is compatible with any scheme at the access network (i.e. connectionless or connection oriented), embodiments of the invention can support QoS and traffic segregation at the AN.

Embodiments of the invention allow supporting physical devices having low power resources, because the connectivity model implemented in embodiments of the invention provides a “physical device wake up” mechanism.

While a particular feature or aspect of the disclosure may have been disclosed with respect to only one of several implementations or embodiments, such feature or aspect may be combined with one or more other features or aspects of the other implementations or embodiments as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the invention beyond those described herein. While the present invention has been described with reference to one or more particular embodiments, those skilled in the art recognize that many changes may be made thereto without departing from the scope of the present invention. It is therefore to be understood that within the scope of the appended claims and their equivalents, the invention may be practiced otherwise than as specifically described herein.

What is claimed is:

1. A control plane, CP, network entity configured to manage communication between an access network, AN, and a core network, CN, of a wireless communication system wherein the CP network entity comprises a processor configured, in response to a connectivity request from a first physical device, to assign the first physical device to a virtual device and to establish an aggregate CN bearer for the virtual device.

2. The CP network entity of claim 1, wherein the processor is configured to provide a virtual address for assigning the first physical device to the virtual device.

3. The CP network entity of claim 1, wherein the processor is configured to provide a physical device tag and to assign the physical device tag to the first physical device for identifying the first physical device as part of the virtual device.

4. The CP network entity of claim 3, wherein the first physical device is associated with a device identifier and a device class parameter and wherein the physical device tag is based on the hash value of a combination, in particular a concatenation, of the device identifier and the device class parameter of the first physical device.

5. The CP network entity of claim 1, wherein the processor is configured to allocate an access CN bearer identifier to the access CN bearer of the virtual device.

6. The CP network entity of claim 1, wherein the first physical device is associated with a device class parameter and wherein the processor is configured, in response to a connectivity request from a second physical device, to assign the second physical device to the virtual device, in case a device class parameter associated with the second physical device is identical to the device class parameter of the first physical device, or, in case the device class parameter associated with the second physical device differs from the device class parameter of the first physical device, to assign the second physical device to a further virtual device and to establish a further aggregate CN bearer for the further virtual device.

7. The CP network entity of claim 6, wherein the processor is configured, in response to a connectivity request from the second physical device, to assign the second physical device to a further virtual device and to establish a further aggregate CN bearer for the further virtual device, in case the device class parameter associated with the second physical device is identical to the device class parameter of the first physical device and the number of physical devices already assigned to the first virtual device is equal to a parameter defining the maximum number of physical devices per virtual device.

8. The CP network entity of claim 7, wherein the processor is configured to use different parameters defining the maximum number of physical devices per virtual device for different device classes.

9. The CP network entity of claim 8, wherein the processor is configured to dynamically adjust the parameters defining the maximum number of physical devices per virtual device.

10. The CP network entity of claim 9, wherein the processor is configured to remove the aggregate CN bearer for the virtual device, in case the first physical device and any other physical device assigned to the virtual device have not been active for a time period, which is larger than an inactivity time period.

11. The CP network entity of claim 10, wherein the processor is configured to remove the aggregate CN bearer for the virtual device, in response to a message from an AN entity indicating that the first physical device and any other physical device assigned to the virtual device have not been active for a time period, which is larger than the inactivity time period.

12. The CP network entity of claim 1, wherein the first physical device is associated with a device class parameter and wherein the processor is configured to establish the aggregate CN bearer for the virtual device on the basis of the device class parameter of the first physical device.

13. A wireless communication system comprising a CP network entity according to claim 12 in communication with an AN entity, in particular an evolved node B, and a DPG network entity, in particular a SGN, a PGN or a combination thereof.

14. A method of operating a control plane, CP, network entity configured to manage communication between an access network, AN, and a core network, CN, of a wireless communication system, wherein the method comprises the steps of:
assigning, in response to a connectivity request from a first physical device, the first physical device to a virtual device; and
establishing an aggregate CN bearer for the virtual device.

15. A computer program comprising program code for performing the method of claim 14 when executed on a computer.
